(19) United States
(12) Patent Application Publication
(10) Pub. No.: US 2011/0174120 A1
(43) Pub. Date: Jul. 21, 2011

(54) TURN-ASSISTED DRIVER

(76) Inventor: Akira Nakamura, Tokyo (JP)

(21) Appl. No.: 12/439,914

(22) PCT Filed: Jun. 6, 2008
(86) PCT No.: PCT/JP2008/060818

§ 371 Date: Jun. 14, 2010

(30) Foreign Application Priority Data
Jun. 30, 2007 (JP) 2007-196719

(51) Int. Cl. B25B 15/00; B25B 23/16

(52) U.S. Cl. 81/436; 81/185.2

(57) ABSTRACT

With a structure capable of idly rotating a main body which is lower than a handle even when fixing the handle in a palm of a hand, a screwdriver can be retained by pushing the handle and rotated at the same time. Therefore, a finger force for retaining the screwdriver is not necessary. The screwdriver can be rotated by one hand. Since a clip chuck for setting the screwdriver is formed in an impeller shape, fingers can be suspended for rotation. Since the rotation can be performed not by grasping but using muscles of the entire hand, fatigue of the muscles can be reduced.

### TECHNICAL FIELD

A function of assisting rotation is attached to a manual screwdriver.

### BACKGROUND ART

A manual screwdriver is integrated with a function of assisting screwdriver rotation which is contents of an unpublished patent application (Japanese Unexamined Patent Application No. 2007-29809) for a screwdriver rotation assist, already applied for a patent.

### DISCLOSURE OF THE INVENTION

### Problems to be Solved by the Invention

When a screwdriver for screws to be used manually is rotated only by hand force, it is tiring and also inefficient.

In a case of rotating while giving a pushing pressure, a palm of a hand becomes a resistance so that the rotation is not smoothly performed. Muscles which are used when rotating the screwdriver are mostly muscles of fingers. Since the muscles to be used are small and limited, it becomes tiring soon. In a case of a wood screw, there is a need for a force. However, when other screws are to be simply rotated, rotating the screws each time by the fingers is rather inefficient.

### Means for Solving the Problems

The first present invention is a screwdriver with a rotation assist, comprising:

a handle portion abutted with a palm of a hand;

a handle axis rotatably coupled to the handle portion;

a chuck portion fixed to the handle axis;

a screwdriver main body retained by the chuck portion; and

a chip fixed to a lower end of the screwdriver main body.

The second present invention is the screwdriver with the rotation assist according to the first present invention, wherein

the chuck portion is formed by two U-shaped members and fixed to the handle axis in a state that bottoms of the U-shaped members are overlapped with each other crosswise, and

side parts of the U-shaped members are projected to an outside so that fingers are easily suspended over.

The third present invention is the screwdriver with the rotation assist according to the second present invention, wherein

the U-shaped members of the chuck portion have a plurality of curved parts,

an entire size of the side parts projected to the outside, of the U-shaped members is larger than a thickness of the handle axis, and

the handle axis is rotatable with a larger force by rotating the side parts projected to the outside, with a smaller force.

The fourth present invention is the screwdriver with the rotation assist according to the second present invention, wherein

a socket hole is dug in an upper end of the screwdriver main body, and

a lower end of the handle axis is fitted into the socket hole.

The fifth present invention is the screwdriver with the rotation assist according to the second present invention, wherein

the screwdriver main body is a rectangular parallelepiped, and

four side surfaces thereof are abutted with sides of the U-shaped members with rigidity thereof.

The sixth present invention is the screwdriver with the rotation assist according to the fifth present invention, wherein

notch portions each having a predetermined depth are formed at parts of the screwdriver main body of the rectangular parallelepiped on which parts, curved portions on top ends of the U-shaped members of the chuck portion abut.

The seventh present invention is the screwdriver with the rotation assist according to the second present invention, wherein

the screwdriver main body is replaceably retained by the chuck portion, or

the chip is replaceably fixed to the screwdriver main body.

The eighth present invention is the screwdriver with the rotation assist according to the seventh present invention, wherein

the screwdriver main body is usable as a normal screwdriver when removed from the chuck portion.

A part which is lower than the handle is to be rotated around so as to rotate the screwdriver under the hand without resistance. In order to rotate not only by rotation force generated by muscles of the fingers but also by utilizing muscles of the entire hand, an outer periphery of the axis is made larger than a conventional example and a large part on which the fingers are caught, is formed.

[First Invention]

[FIGS. 1 to 3]

D portion can be rotated around an axis C while fixing a handle portion A. The first invention is a method and a structure of the screwdriver capable of rotating a clip chuck for setting the screwdriver and the main body of the screwdriver around the handle axis while fixing the handle in the palm of the hand.

[Second Invention]

The clip chuck for setting the screwdriver is formed into a crosswise impeller shape. The second invention is a method and a structure of the clip chuck for the screwdriver, capable of strongly and easily rotating, since an outer periphery of the impeller is larger than the outer periphery of the screwdriver axis, and capable of hanging an index finger, a middle finger or the like for rotation on a part of the impeller.

[Third Invention]

The screwdriver is set by putting the handle axis C into an axis setting hole E1. Thereby, since vertical directions of the handle axis C and the screwdriver correspond to each other, the axis is prevented from being moved by force from a horizontal direction. The third invention is a method and a structure for setting, by inserting the handle axis into a socket hole of the screwdriver.

[Fourth Invention]

Reference symbols D1 and D2 in FIGS. 1 to 3 are base parts of the clip chuck. As shown in FIG. 3, the parts are formed in a square shape to be unevenly but closely adhered to four surfaces of a square of the screwdriver. These robust square parts suppress force in a rotational direction imposed on a rotation axis of the screwdriver. The fourth invention is a structure for suppressing the force in the rotational direction imposed on the rotation axis of the screwdriver by making the screwdriver axis square and setting the screwdriver axis in a quadrilateral generated by forming clip springs to be crosswise.

[Fifth Invention]

Reference symbols D3 and D4 in FIGS. 1 to 3 are top end parts of the clips. Since the clips are spring clips, the force is inwardly imposed on the top end parts shown in FIG. 3 so as to retain and prevent the screwdriver from slipping out. The fifth invention is a method and a structure of the clip chuck in which the spring clips retain and prevent the screwdriver from slipping out.

[Sixth Invention]

A screwdriver E in FIG. 1 can be easily removed as shown in FIG. 2. The sixth invention is a system and a structure of the screwdriver, capable of being set for use or removed for use according to need, and capable of realizing a quick exchange and various usage, by changing to a screwdriver in which a top end part E2 is different, for example provided with a plus shaped chip or changing the chip itself according to need.

### Effects of the Invention

### Reduction in Fatigue

When a conventional screwdriver is used, fingers for rotating the screwdriver serve for both rotation and retention of the screwdriver. Therefore, the screwdriver is necessarily rotated by grasping with the fingers and the fingers become tired. However, in a case of using a screwdriver with a rotation assist, the screwdriver can be retained while pushing the screwdriver with a palm of a hand. Therefore, the fingers become free, muscles of the entire fingers or muscles of the entire hand can be used for a rotation action, and hence a degree of fatigue is reduced.

Efficient Rotation and Reduction in Working Time

When a handle portion is retained, a part which is lower than the handle can be idly rotated. At the time of an intermediate process of screw fastening which does not require the force or during screw loosing which does not require the force or the like, the rotation can be performed so as to idly rotate, and hence the rotation can be effectively performed.

The conventional screwdriver is used by grasping the screwdriver with a thumb and an index finger, a middle finger or the like. However, suspending rotation of suspending the fingers over impeller blade parts can be performed by this screwdriver. In this case, since the rotation can be performed by not using the thumb but the index finger and the middle finger, the screwdriver can be effectively used when the rotation is performed so as to idly rotate.

Strong Fastening

Since an outer circumference of the clip chuck with an impeller shape is large, strong fastening can be easily performed.

Improvement in Workability with Both Hands

In a case where the handle is held by a right hand and the screwdriver itself is rotated by a left hand, the left hand is completely free. Therefore, the screwdriver can be largely rotated, and hence workability is improved.

### BRIEF DESCRIPTION OF THE DRAWINGS

FIG. 10

A front view of a screwdriver with a rotation assist of an embodiment of the present invention.

FIG. 2

A side view of the screwdriver.

FIG. 3

A bottom view of the screwdriver.

FIG. 4

A front view of the screwdriver from which a screwdriver main body is removed.

FIG. 5

A bottom view of FIG. 4.

FIG. 6

A front view of the screwdriver main body of the screwdriver.

FIG. 7

A bottom view of FIG. 6.

FIG. 8

A perspective view of the screwdriver.

FIG. 9

A front view of a screwdriver with a rotation assist of another embodiment of the present invention.

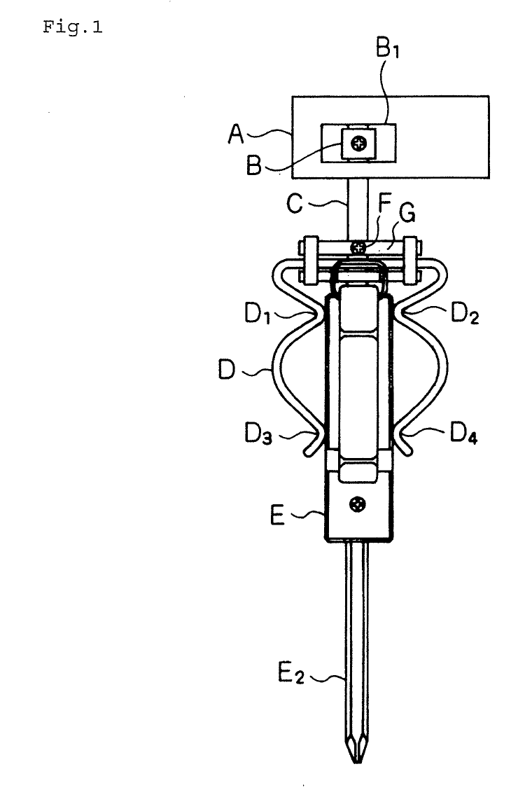

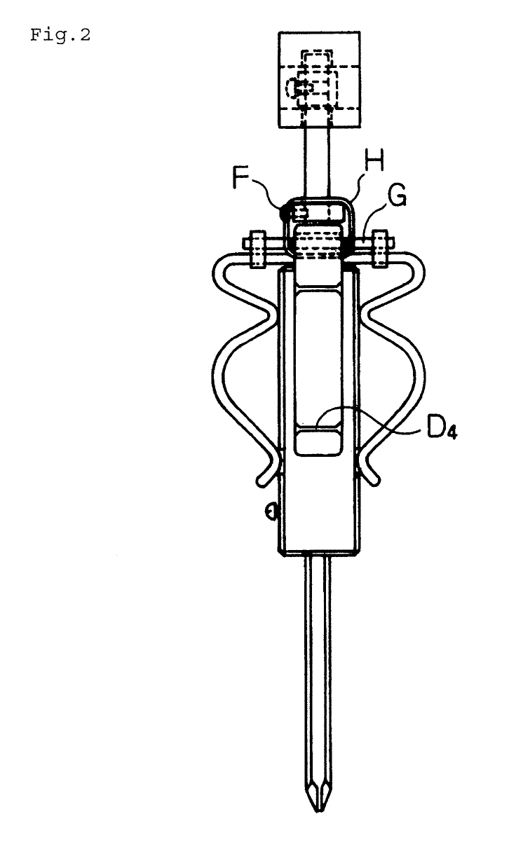

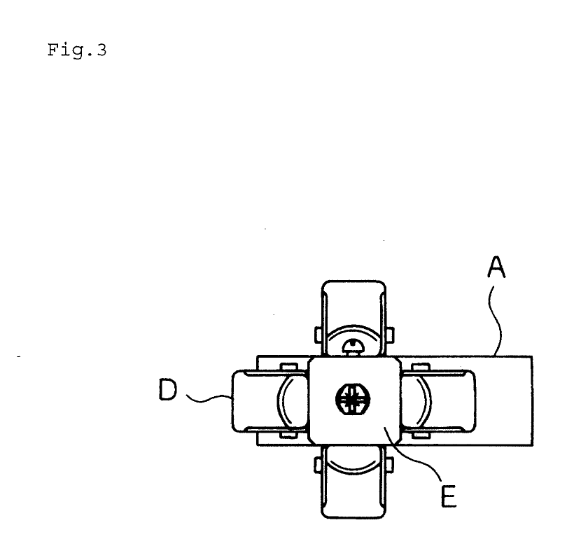

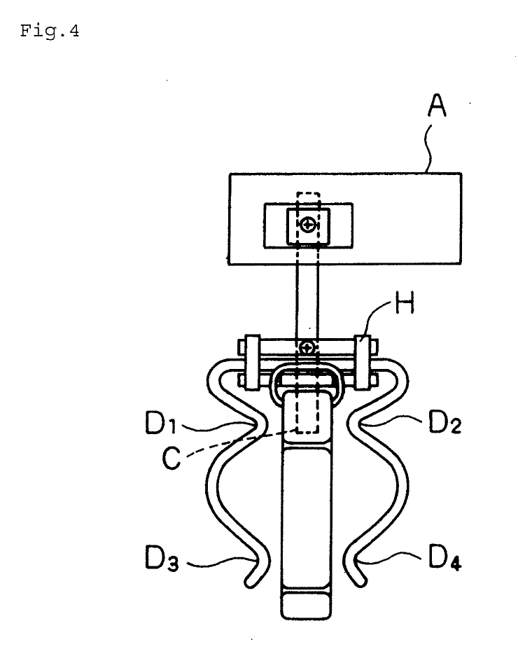

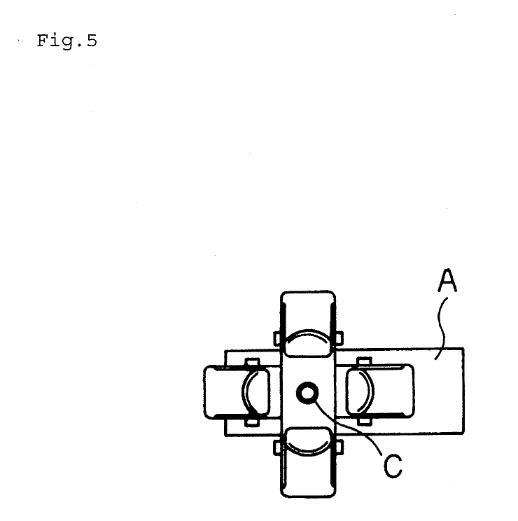

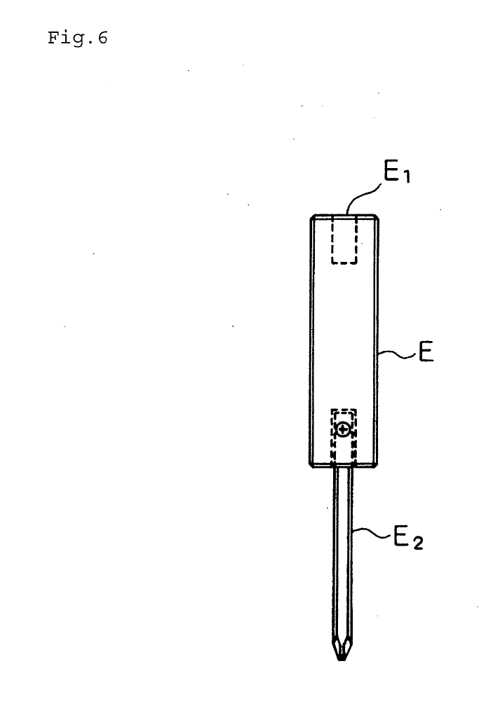

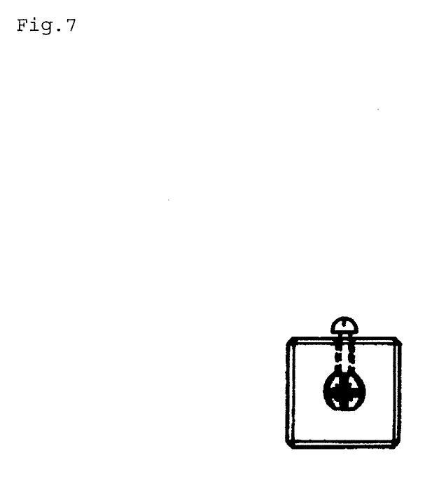

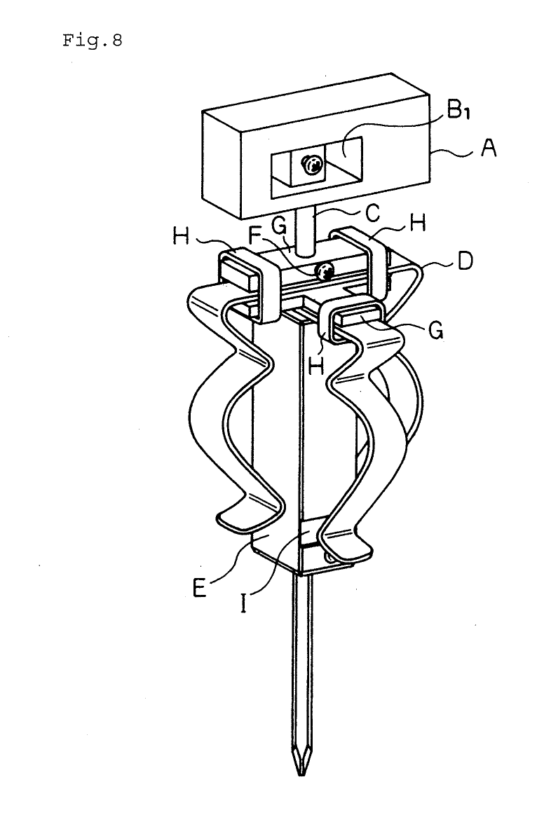

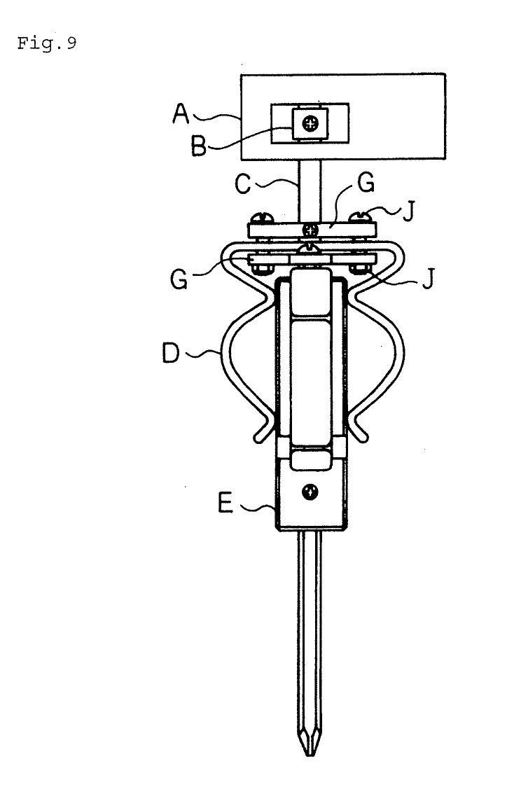

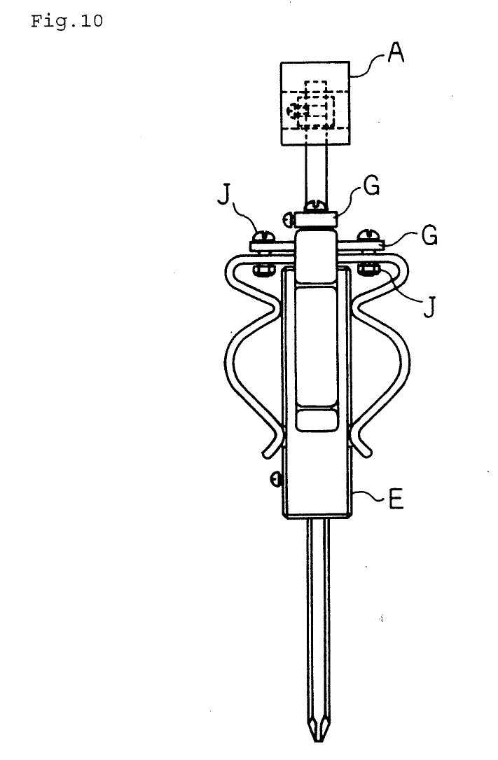

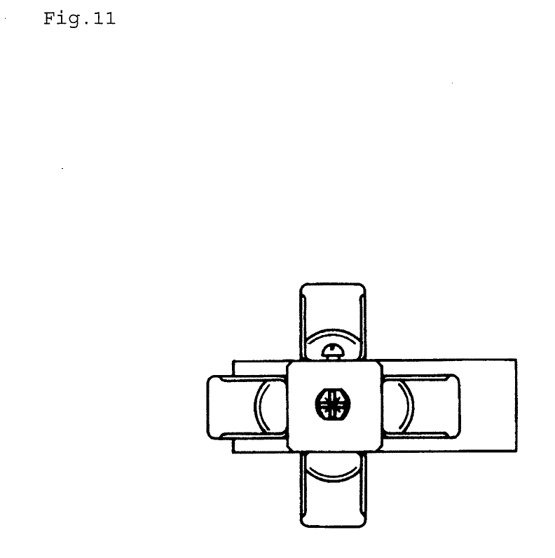

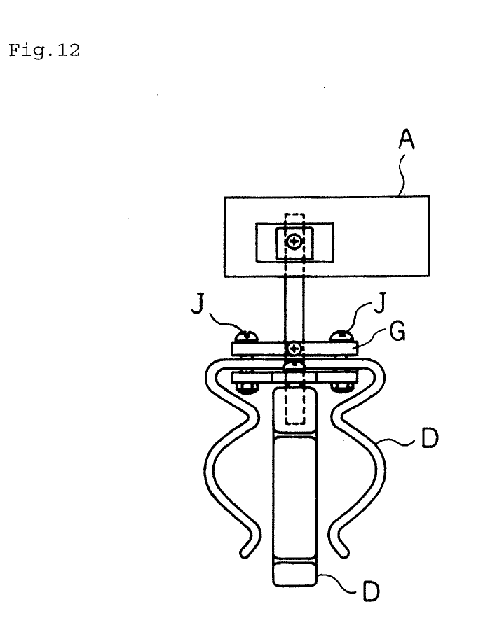

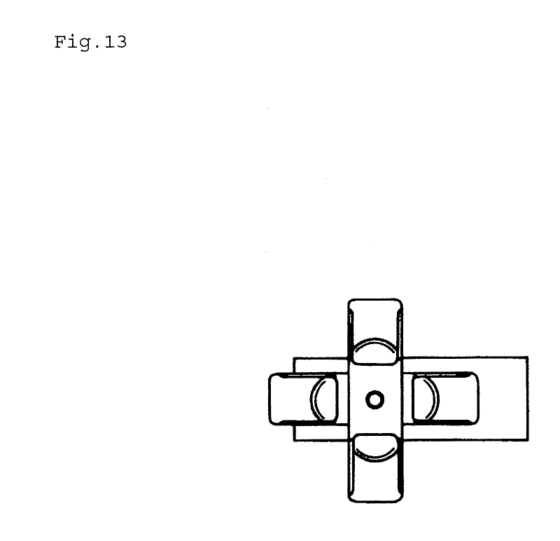

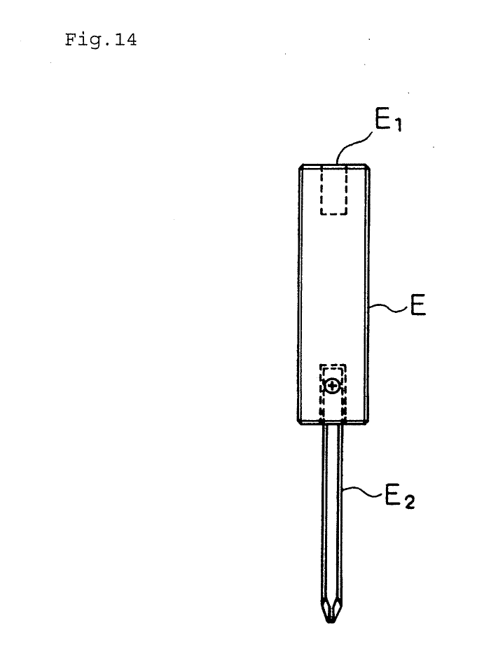

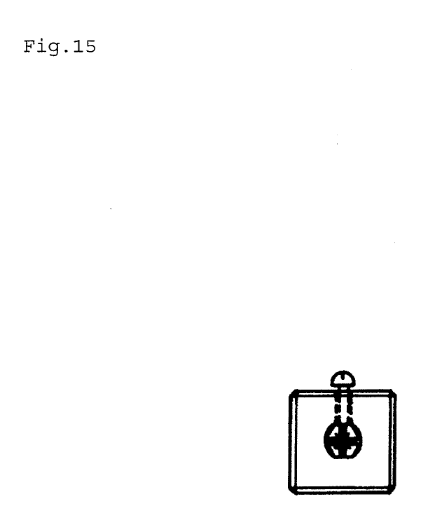

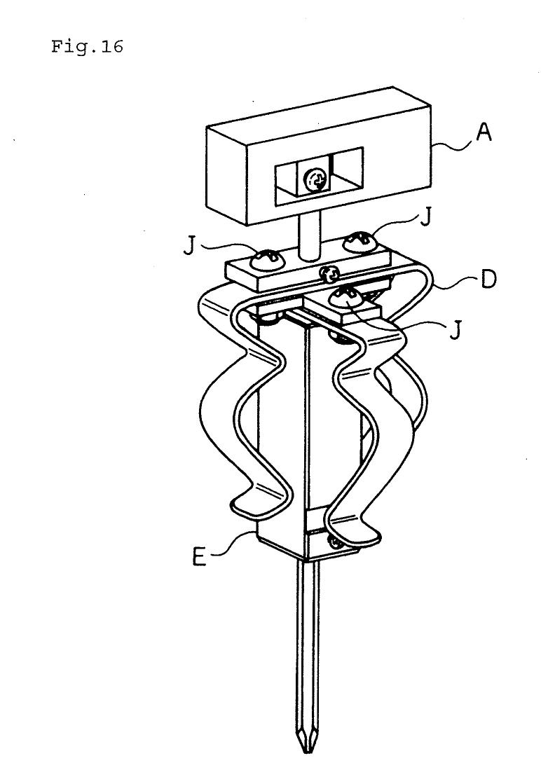

FIG. 10

A side view of the screwdriver.

FIG. 11

A bottom view of the screwdriver.

FIG. 12

A front view of the screwdriver from which a screwdriver main body is removed.

FIG. 13

A bottom view of FIG. 12.

FIG. 14

A front view of the screwdriver main body of the screwdriver.

FIG. 15

A bottom view of FIG. 14.

FIG. 16

A perspective view of the screwdriver.

### DESCRIPTION OF REFERENCE SYMBOLS

A denotes a handle, B denotes a handle fixing tool, B1 denotes a horizontal hollow, C denotes a handle axis, D denotes a clip chuck, D1 and D2 denote base parts of clip chuck, D3 and D4 denote top ends of clip chuck, E denotes a screwdriver, E1 denotes a socket hole of the screwdriver, E2 denotes a screwdriver chip, F denotes a screw, G denotes a support plate, H denotes a band, I denotes a notch portion, and J denotes a screw.

### BEST MODES FOR CARRYING OUT THE INVENTION

FIG. 1 is a front view of a screwdriver, FIG. 2 is a side view thereof, and FIG. 3 is a bottom view thereof. FIG. 8 is a perspective view thereof.

In FIGS. 1 to 3, a reference symbol A denotes a handle. The handle has narrow width so as to be easily put in a palm of a hand, and a length of one side is short and a length of the other side is long. In a case of using the handle with only a right hand, and in a case where the short side is abutted with a base of an index finger, the index finger and a middle finger can be brought to a left-front side as there is nothing ahead, and a movable range can be widely used.

The handle is long on a side of a wrist. Therefore, when a position of the hand is moved to the side of the wrist, the movable range of the hand can be changed.

A reference symbol B in FIGS. 1 to 3 denotes a handle fixing tool for preventing the handle from slipping out of an axis. However, since the handle itself is not fixed, the handle is prevented from slipping out and a part which is lower than the handle is rotatable. In other words, a horizontal hollow B1 is provided in the handle A, and a hole through which a handle axis C passes from a lower side is further provided in the hollow B1. Further, an upper end of the handle axis C is fitted into the through hole and at the same time a circular fixing tool which is larger than the through hole is fitted into the upper end of the handle axis C. Further, the fixing tool is fixed to the handle axis C by a screw.

By such a structure, the handle axis C is coupled to the handle A and is rotatable.

A reference symbol E in FIGS. 1 to 3 denotes a screwdriver main body, and a reference symbol D denotes a clip chuck portion for setting the screwdriver. This chuck portion is formed by crosswise putting bottom parts of U-shaped members having two curved parts and coupling the U-shaped members to each other by a band H with utilizing support plates G. Further, these support plates G are fixed to the handle axis C by a screw F. As mentioned above, this chuck portion has a shape of an impeller formed by putting spring clips crosswise. It should be noted that the U-shaped members are metal members having a certain degree of elasticity at top ends thereof and strong rigidity at base parts near bottoms thereof.

Taking a case of rotating with a right hand as an example, the chuck portion formed by crosswise putting the two U-shaped members can be rotated by suspending fingers of the right hand over impeller blade parts, that is, side parts of the U-shaped members.

Size of the entire clip chuck (size of the entire side parts of the U-shaped members, circle diameter) is larger than the handle axis C, and it is easy to apply a force. Therefore, suspending rotation can be performed by not using a thumb but only an index finger, a middle finger or the like. Even when the handle is held by the right hand and a part of the impeller is rotated in a palm of a left hand, the screwdriver can be easily and largely rotated.

The screwdriver is set by inserting the handle axis C into a socket hole E1. Thereby, vertical directions of the handle axis C and the screwdriver correspond to each other, and the axis is prevented from being moved by the force from a horizontal direction.

Reference symbols D1 and D2 in FIG. 1 are the base parts of the clip chuck. As shown in FIG. 3, the parts are formed in a square shape to be unevenly but closely adhered to four surfaces of a square of the screwdriver. These robust square parts are to endure the force in a rotational direction imposed on a rotation axis of the screwdriver.

Reference symbols D3 and D4 in FIG. 1 are top end parts of the clip chuck. Since the clips are spring clips, the force is inwardly imposed on the top end parts shown in FIG. 3 so as to retain and prevent the screwdriver from slipping out.

The screwdriver E in FIG. 1 can be easily removed as shown in FIGS. 4, 5, 6 and 7. According to need, the screwdriver can be set for use or removed for use. According to need, when the screwdriver is changed to a screwdriver in which a top end part E2 is different, for example, provided with a plus shaped chip or the chip itself is changed, a quick exchange and various usage can be realized.

It should be noted that the screwdriver main body is usable as a normal screwdriver when removed from the chuck portion.

FIG. 9 is a front view of a screwdriver with a rotation assist of another embodiment of the present invention. FIG. 10 is a side view of the screwdriver. FIG. 11 is a bottom view of the screwdriver. FIG. 12 is a front view of the screwdriver from which a screwdriver main body is removed. FIG. 13 is a bottom view of FIG. 12. FIG. 14 is a front view of the screwdriver main body of the screwdriver. FIG. 15 is a bottom view of FIG. 14. FIG. 16 is a perspective view of the screwdriver.

Another embodiment is different from the screwdriver of the above-mentioned embodiment in terms of the following point. That is, in the above-mentioned embodiment, the support plates G are fixed to each other by the band H and also coupled with the clip chuck portion D so as to be fixed to the axis C.

Meanwhile, another embodiment has a different point that the support plates G are fixed to each other by a screw J and also coupled with the clip chuck portion D so as to be fixed to the axis C.

1. A screwdriver with a rotation assist, comprising:
a handle portion abutted with a palm of a hand;
a handle axis rotatably coupled to the handle portion;
a chuck portion fixed to the handle axis and placed at a lower position than the handle portion;
a screwdriver main body retained by the chuck portion; and
a chip fixed to a lower end of the screwdriver main body, wherein
the chuck portion is formed by two U-shaped members and fixed to the handle axis in a state that bottoms of the U-shaped members are overlapped with each other crosswise,
side parts of the U-shaped members are curved and projected to an outside so that fingers are easily suspended over, and
an entire size of the side parts projected to the outside of the U-shaped members is larger than a thickness of the screwdriver main body.

2.-3. (canceled)

4. The screwdriver with the rotation assist according to claim 1, wherein
a socket hole is dug in an upper end of the screwdriver main body, and
a lower end of the handle axis is fitted into the socket hole.

5. The screwdriver with the rotation assist according to claim 1, wherein
the screwdriver main body is a rectangular parallelepiped, and
four side surfaces thereof are abutted with sides of the U-shaped members with rigidity thereof.

6. The screwdriver with the rotation assist according to claim 5, wherein
side parts of the U-shaped members have a plurality of curved parts and the side parts, and
notch portions each having a predetermined depth are formed at parts of the screwdriver main body of the rectangular parallelepiped on which parts, curved portions on top ends of the U-shaped members of the chuck portion abut.

7. The screwdriver with the rotation assist according to claim 1, wherein
the screwdriver main body is replaceably retained by the chuck portion, or
the chip is replaceably fixed to the screwdriver main body.

8. The screwdriver with the rotation assist according to claim 7, wherein
the screwdriver main body is usable as a normal screwdriver when removed from the chuck portion.
